(19) United States
(12) Patent Application Publication
(10) Pub. No.: US 2026/0306317 A1
(43) Pub. Date: Oct. 8, 2026

(54) MOUNTING STRUCTURE OF RAMP MODULE OF VEHICLE

(71) Applicants: Hyundai Motor Company, Seoul (KR); Kia Corporation, Seoul (KR)

(72) Inventors: Jiae Yong, Hwaseong-si (KR); Jungho Han, Hwaseong-si (KR); Jinyoung Mo, Hwaseong-si (KR); Jejoon Lee, Hwaseong-si (KR); Hyeongwoon Lee, Hwaseong-si (KR); Chulhee Heo, Hwaseong-si (KR); Byeongkyu Kwon, Hwaseong-si (KR)

(21) Appl. No.: 19/578,374

(22) Filed: Mar. 25, 2026

(30) Foreign Application Priority Data
Apr. 2, 2025 (KR) 10-2025-0042543
Nov. 10, 2025 (KR) 10-2025-0168605

(51) Int. Cl. A61G 3/06; B60P 1/43

(52) U.S. Cl. CPC A61G 3/061; B60P 1/431

(57) ABSTRACT

A ramp module mounting structure of a vehicle installed on a vehicle body inside the vehicle, and the ramp module mounting structure may include an in-floor ramp module disposed on a floor surface of the vehicle body and configured to be slidably moved toward an outside of the vehicle body in a transverse direction of the vehicle body, longitudinal side members, wherein each of the longitudinal side members fixes a position of the in-floor ramp module at both sides of the in-floor ramp module, and a battery disposed at a lower portion of the in-floor ramp module.

### CROSS-REFERENCE TO RELATED APPLICATIONS

This application claims priority to and the benefit of Korean Patent Application No. 10-2025-0042543 filed with the Korean Intellectual Property Office on Apr. 2, 2025, and Korean Patent Application No. 10-2025-0168605 filed with the Korean Intellectual Property Office on Nov. 10, 2025, the entire contents of which are incorporated herein by reference.

### TECHNICAL FIELD

The present disclosure relates to a ramp module mounting structure of a vehicle.

### BACKGROUND

In general, a boarding/alighting assisting step (i.e., ramp system) is installed and used in a vehicle in which a person with reduced mobility ride. A ramp system is mainly used in an under-floor insertion type in which it is inserted in an under-floor of the vehicle and protrudes to the outside of the vehicle when necessary, or a separate-unit type using a separate device stored in a trunk space of the vehicle.

In the case of a vehicle in which a user uses a wheelchair, a vehicle body on a trunk side of the vehicle is entirely cut to secure a space into which the wheelchair or the like can enter, and a separate ramp device stored in the trunk space is used. The ramp device connected to a floor inside the vehicle through the cut vehicle body on the trunk side, and the wheelchair may enter the inside of the vehicle or get off the vehicle by opening a door on the trunk side.

In the case of the separate-unit type, it is difficult to secure a space for storing the ramp device when the ramp device is not used, and because a user needs to directly install the ramp device every time it is used due to high weight, there are difficulties in storage and use. In addition, such a vehicle type is manufactured by a specialized vehicle conversion company, and because it is manufactured at high costs, the customer base is limited.

In the case of a ramp module mounting type, a planarized structure is required as a wheelchair movement path on an upper portion of a ramp module such that a wheelchair passenger can move smoothly inside the vehicle. In addition, it is important to ensure the safety of the wheelchair passenger by allowing the wheelchair to be fixed during movement.

### SUMMARY

The present disclosure relates to a ramp module mounting structure of a vehicle, and more particularly, the present disclosure relates to a ramp module mounting structure of a vehicle, in which an in-floor ramp module entering/leaving through a side portion of the vehicle and a device restraining a wheelchair in the vehicle are provided.

Some embodiments of the present disclosure may solve the above-described problems, and, according to some embodiments of the present disclosure, a ramp module mounting structure for a vehicle, which enables maximum parts commonality by utilizing an existing lower radial vehicle body member of a conventional vehicle without changing the vehicle type, and enhances user convenience by adopting an in-floor ramp module configured to enter and leave the vehicle through a side portion of the vehicle and improves the strength and durability of the vehicle, can be provided.

A ramp module mounting structure of a vehicle according to some embodiments of the present disclosure may include: in a ramp module installed in a vehicle body inside the vehicle, at least one in-floor ramp module provided on a floor surface of the vehicle body and provided to be slidably moved toward an outside of the vehicle body in a transverse direction of the vehicle body; and a longitudinal side member fixing a position of the in-floor ramp module at both side portions of the in-floor ramp module and a battery module disposed at a lower portion of the in-floor ramp module.

A ramp module mounting structure of a vehicle according to some embodiments of the present disclosure may further include: a front planarization panel provided on the floor surface of the vehicle body and disposed at a front end portion of the in-floor ramp module to form a planarized surface with the in-floor ramp module; and a rear planarization panel provided on the floor surface of the vehicle body and disposed at a rear end portion of the in-floor ramp module to form a planarized surface with the in-floor ramp module.

In a ramp module mounting structure of a vehicle according to some embodiments of the present disclosure, a wiring may be provided at one side of the vehicle body and a slide ramp operation portion may be provided at an opposite side of the wiring to lower a height of the in-floor ramp module and reduce a slide protrusion length according to the height.

A side sill may be provided at an outer portion of the longitudinal side member, a patch panel may be attached to an upper surface of the side sill, and a ramp module assembly guide to which an end portion of the in-floor ramp module is assembled may be provided in an upper portion of the patch panel.

A ramp module mounting structure of a vehicle according to some embodiments of the present disclosure may further include a side ramp module coupling bracket provided to protrude from the end portion of the in-floor ramp module and coupled with the ramp module assembly guide to fix the in-floor ramp module.

A height of the ramp module assembly guide and a height of the side ramp module bracket may be formed to be higher than a height of a pre-assembled slide wiring so as not to interfere with the slide wiring.

An interior of the side sill may form an annular structure in which a plurality of panels are provided while forming intervals.

The in-floor ramp module may be provided with a housing forming a planarized surface with the front planarization panel and the rear planarization panel.

In a lower portion of the in-floor ramp module, a transverse battery member of which both ends are connected to the longitudinal side member, and extending in a transverse direction of the vehicle body and having the battery module mounted thereon, and an extension member connecting the vehicle body and the transverse battery member and extending in a longitudinal direction of the vehicle body may further be provided.

The extension member may be formed of a front extension member connecting the front vehicle body and the transverse battery member, and a rear extension member connecting the rear vehicle body and the transverse battery member.

A front ramp module coupling bracket mounted to the front extension member may be provided in a front side the in-floor ramp module, and a rear ramp module coupling bracket mounted to the rear extension member may be provided in a rear side of the in-floor ramp module.

A ramp slide protrusion portion formed to extend toward the outside of the vehicle body from an upper portion of the side sill may be provided at one side portion of the in-floor ramp module.

A center floor panel may be provided between a lower portion of the in-floor ramp module, the longitudinal side member, the transverse battery member, and the extension member.

A plurality of negative beads may be formed on an upper surface of the center floor panel.

A wheelchair restraint device may be further provided on the floor surface of the vehicle body to fix a wheelchair placed on the vehicle body the in-floor ramp module.

The wheelchair restraint device may be formed of: a front wheelchair restraint device protruding toward an upper surface of the front planarization panel; and a rear wheelchair restraint device protruding toward an upper surface of the rear planarization panel.

According to some embodiments of the present disclosure, by employing a structure for mounting an in-floor ramp module for boarding of a transportation-vulnerable person to a lower radial vehicle body member, it is possible to respond to a multi-specification purpose-built vehicle (PBV) market by maximizing commonality without changes to existing vehicle models.

In some embodiments of the present disclosure, by employing a ramp device capable of planarization together with a planarization panel, an appearance becomes aesthetic and loading and usability can be improved.

In some embodiments of the present disclosure, by employing a side sill forming an annular structure provided with a plurality of panels disposed at intervals, rigidity and durability of a vehicle body can be improved.

In some embodiments of the present disclosure, after mounting the ramp module, the entire in-floor surface may be planarized and a device for restraining a wheelchair may be adopted, thereby improving ride comfort and safety.

### BRIEF DESCRIPTION OF THE DRAWINGS

FIG. 1 is a perspective view of a ramp module mounting structure of a vehicle according to an example embodiment of the present disclosure being used in a vehicle.

FIG. 2 shows a state in which a ramp module mounting structure of a vehicle according to an example embodiment of the present disclosure is installed inside the vehicle.

FIGS. 3 to 8 illustrate a process in which a ramp module mounting structure of a vehicle according to an example embodiment of the present disclosure is installed inside the vehicle.

FIG. 9 shows a state in which an in-floor ramp module of a ramp module mounting structure of a vehicle according to an example embodiment of the present disclosure is installed above a center floor panel inside the vehicle.

FIG. 10 shows a ramp module assembly guide to which an end portion of an in-floor ramp module of a ramp module mounting structure of a vehicle according to an example embodiment of the present disclosure is assembled.

FIG. 11 shows a state in which a side ramp module coupling bracket of a ramp module mounting structure of a vehicle according to an example embodiment of the present disclosure is coupled and fixed to a ramp module assembly guide.

FIG. 12 partially cut-away perspective view of a structure of a side sill of a ramp module mounting structure of a vehicle according to an example embodiment of the present disclosure.

FIG. 13 shows an arrangement structure of members disposed at a lower portion of an in-floor ramp module of a ramp module mounting structure of a vehicle according to an example embodiment of the present disclosure.

FIG. 14 shows a state in which an in-floor ramp module of a ramp module mounting structure of a vehicle according to an example embodiment of the present disclosure is mounted on members disposed at a lower portion of the in-floor ramp module.

FIG. 15 shows front and rear ramp module coupling brackets provided in an in-floor ramp module of a ramp module mounting structure of a vehicle according to an example embodiment of the present disclosure.

FIG. 16 shows an arrangement relationship between an in-floor ramp module, a side member, and a side sill of ramp module mounting structure of a vehicle according to an example embodiment of the present disclosure.

FIG. 17 shows a center floor panel on which an in-floor ramp module of a ramp module mounting structure of a vehicle according to an example embodiment of the present disclosure is mounted.

FIG. 18 is a cross-sectional view of FIG. 17, taken along the line <A-A>.

FIG. 19 is a cross-sectional view of FIG. 17, taken along the line <B-B>.

FIG. 20 is a cross-sectional view of FIG. 17, taken along the line <C-C>.

FIG. 21 is a perspective view of a planarized region of a ramp module mounting structure of a vehicle according to an example embodiment of the present disclosure.

FIG. 22 is a cross-sectional view of a planarized region of a ramp module mounting structure of a vehicle according to an example embodiment of the present disclosure.

FIG. 23 shows a state in which a planarization panel of a ramp module of a vehicle is provided according to an example embodiment of the present disclosure.

FIG. 24 shows planarization panel mounting brackets of a ramp module mounting structure of a vehicle according to an example embodiment of the present disclosure.

FIG. 25 shows a state in which planarization panel mounting brackets of a ramp module mounting structure of a vehicle according to an example embodiment of the present disclosure are coupled with a transverse battery member through an extension member.

FIG. 26 shows a state in which a wheelchair restraint device is installed on a floor surface of a vehicle body of a ramp module mounting structure of a vehicle according to an example embodiment of the present disclosure.

FIG. 27 shows a state in which an in-floor ramp module, a planarization panel, and a wheelchair restraint device are installed in a ramp module mounting structure for a vehicle according to an example embodiment of the present disclosure.

FIG. 28 shows a wheelchair restraint device of a ramp module mounting structure of a vehicle according to an example embodiment of the present disclosure.

### DETAILED DESCRIPTION OF ILLUSTRATIVE EMBODIMENTS

Hereinafter, some example embodiments of the present disclosure will be described in a clear and detailed manner with reference to the accompanying drawings so that those of ordinary skill in the art to which the present disclosure pertains can easily implement the same. As those skilled in the art may realize, the described example embodiments may be modified in various different ways for other embodiments of the present disclosure without departing from the spirit or scopes of the present disclosure.

In various example embodiments, components having the same configuration may be denoted by the same reference numerals.

The drawings may be schematic and are not necessarily drawn to scale. The relative sizes and proportions of elements illustrated in the drawings may be exaggerated or reduced for clarity and convenience of description, and any dimensions provided herein are merely illustrative and not necessarily limiting. When identical or similar structures, elements, or components are shown in two or more drawings, the same reference numerals may be used to denote the same or corresponding features. When a component is described as being positioned “on” or “above” another component, it may be directly on the other component or intervening components may also be present therebetween.

The example embodiments of the present disclosure are provided to illustrate the technical spirit of the present disclosure. Accordingly, the present disclosure is not necessarily limited to the specific shapes or structures shown in the drawings. Thus, various modifications are possible for other embodiments of the present disclosure, including changes in form resulting from manufacturing processes.

Next, with reference to the accompanying drawings, ramp module mounting structures of a vehicle according to some embodiments of the present disclosure will be described in detail.

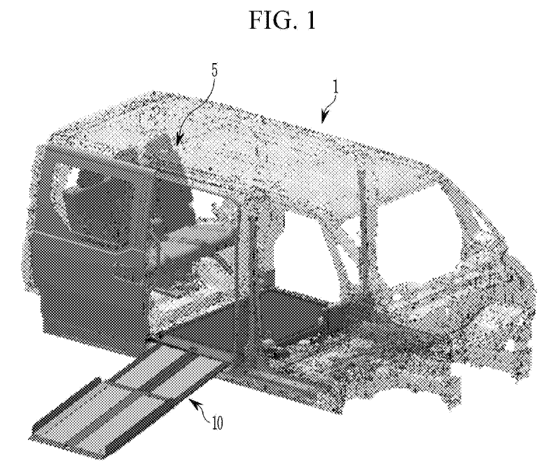

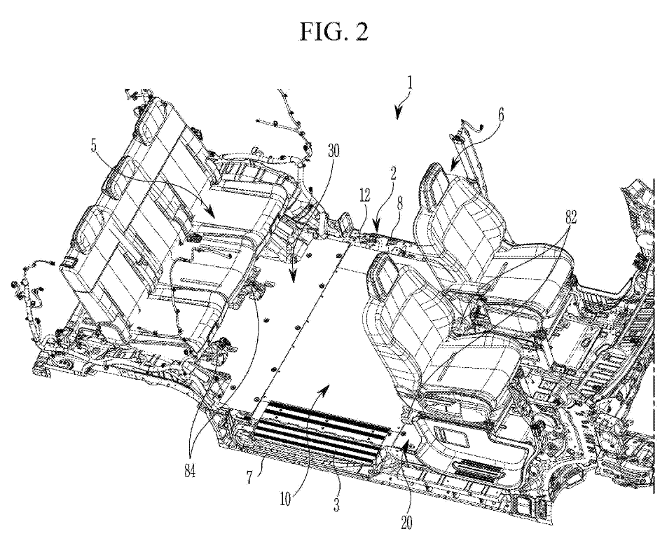

FIG. 1 is a perspective view of a ramp module mounting structure of a vehicle according to an example embodiment of the present disclosure being used in a vehicle. FIG. 2 shows a state in which a ramp module mounting structure of a vehicle according to an example embodiment of the present disclosure is installed inside the vehicle.

Referring to FIG. 1, an in-floor ramp module 10 of a vehicle according to some embodiments of the present disclosure may be connected to a floor inside the vehicle, and a wheelchair may enter the vehicle or get off the vehicle by opening a side door of the vehicle.

The ramp module mounting structure of the vehicle according to some embodiments of the present disclosure may be configured with at least in-floor ramp module 10 provided on a floor surface of a vehicle body 1, and a longitudinal side member 40 may be fixing a position of the in-floor ramp module 10.

In some embodiments, the in-floor ramp module 10 may be provided on the floor surface of the vehicle body 1, and may be slidable in a transverse direction of the vehicle body 1 toward an exterior of the vehicle body 1. In some embodiments, the in-floor ramp module 10 may be formed of a ramp housing and a plurality of plates connected to be slidable in the ramp housing. The plurality of plates may be disposed to overlap each other in the vehicle, and when being protruded, an upper plate may protrude to the outside of the vehicle by slidely moving with respect to a lower plate.

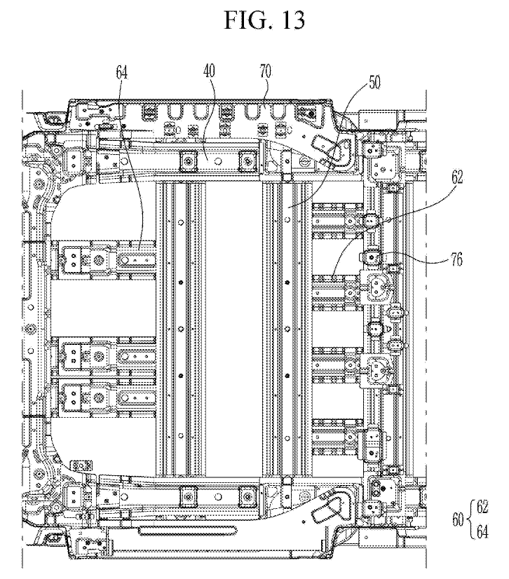

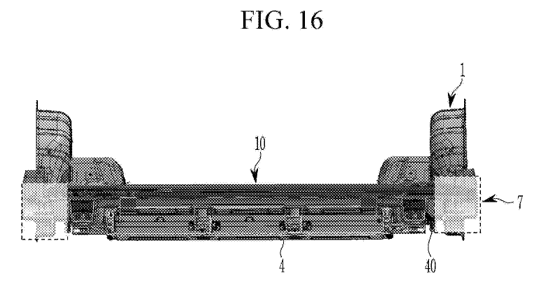

In some embodiments, as illustrated in FIG. 16, a battery module 4 may be installed below the in-floor ramp module 10, and as illustrated in FIG. 13, a position of the ramp module 10 may be fixed by the longitudinal side member 40 that forms a side of the vehicle body 1 at lateral side portions of the in-floor ramp module 10 and the battery module 4. In some embodiments, a side seal 7 may be provided at lateral side portions of the longitudinal side member 40.

Referring to FIG. 2, a ramp module mounting structure of the vehicle according to some embodiments of the present disclosure may further include a front planarization panel 20 and a rear planarization panel 30. In some embodiments, the front planarization panel 20 may be provided on the floor surface of the vehicle body 1, and may be disposed on a front end portion of the in-floor ramp module 10. In some embodiments, the rear planarization panel 30 may be provided on the floor surface of the vehicle body 1, and may be disposed at a rear end portion of the in-floor ramp module 10.

In some embodiments, the front planarization panel 20 and the rear planarization panel 30 may have the same height as an upper surface of the in-floor ramp module 10, and may planarize a floor surface of the inside of the vehicle. Thus using some embodiments, a wheelchair occupant can smoothly and safely move inside the vehicle.

In some embodiments, a wiring 2 of the vehicle body 1 may be provided on the opposite side of a slide ramp operation portion 3. In some embodiments, with the wiring 2 being provided on the opposite side of the slide ramp operation portion 3, the configuration may thereby decrease a height of the ramp module 10 and reduce a slide protrusion length according to the height.

In some embodiments, a front seat 6 may be provided at a front side of (in front of) the in-floor ramp module 10, and a tip-up seat 5 may be installed at a rear side of (behind) the in-floor ramp module 10. In some embodiments, the front seat 6 may be disposed and supported on an upper surface of the front planarization panel 20, and the tip-up seat 5 may be disposed and supported on an upper surface of the rear planarization panel 30.

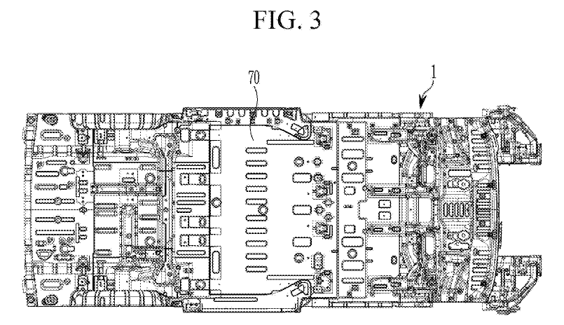

FIGS. 3 to 8 show a process in which a ramp module mounting structure of a vehicle according to some embodiments of the present disclosure may be installed inside the vehicle.

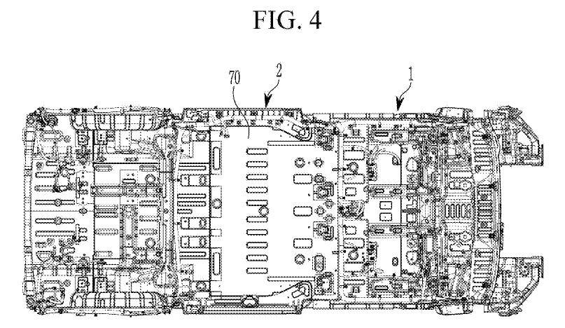

In some embodiments, a center floor panel 70 may be installed on the floor surface of the vehicle body 1 (as illustrated in FIG. 3), and after that, a sliding wiring 2 may be installed on a side sill 7 of the vehicle body (as illustrated in FIG. 4).

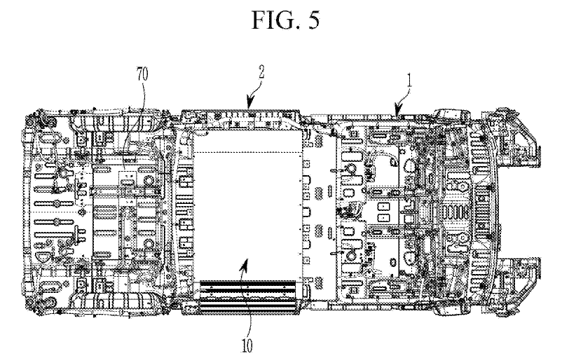

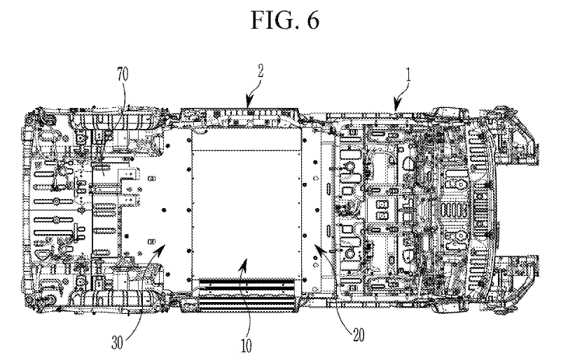

Thereafter, in some embodiments, at least one in-floor ramp module 10 may be installed on an upper surface of the center floor panel 70 (as illustrated in FIG. 5). Thereafter, in some embodiments, a front planarization panel 20 and a rear planarization panel 30 may be installed on the floor surface of the vehicle body 1 so as to partially overlap the center floor panel 70 (as illustrated in FIG. 6). In some embodiments, the front planarization panel 20 may be disposed at a front end of the in-floor ramp module 10 to form a planarized surface with the in-floor ramp module 10, and the rear planarization panel 30 may be disposed at a rear end portion of the in-floor ramp module 10 to form a planarized surface with the in-floor ramp module 10.

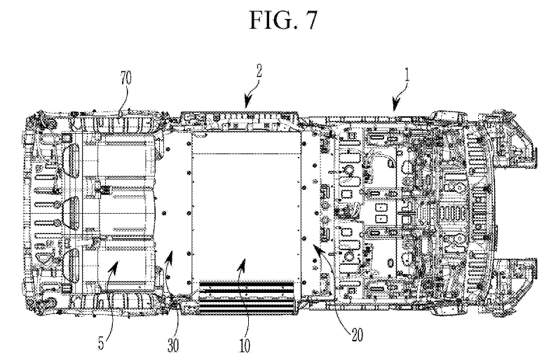

After that, in some embodiments, at a rear of the in-floor ramp module 10, a tip-up seat 5 may be mounted on the floor surface of the vehicle body 1 (as illustrated in FIGS. 2 and 7), and at a front of the in-floor ramp module 10, a front seat 6 may be installed on the floor surface of the vehicle body 1 (as illustrated in FIG. 2).

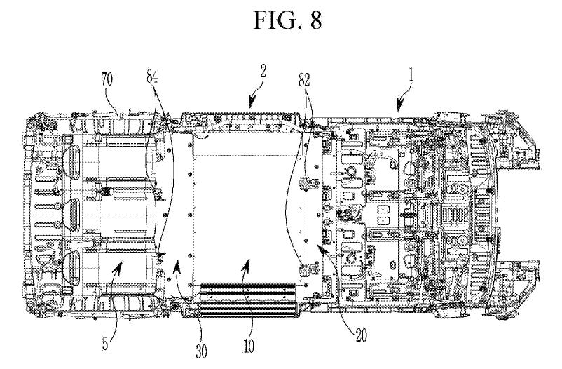

Thereafter, in some embodiments, a front wheelchair restraint device 82 that can fix a front portion of a wheelchair may be installed on the upper surface of the front planarization panel 20, and a rear wheelchair restraint device 84 that can fix a rear portion of the wheelchair may be installed on the upper surface of the rear planarization panel 30 (as illustrated in FIG. 8). The front portion and the rear portion of the wheelchair may be front wheels and rear wheels of the wheelchair, respectively, for example.

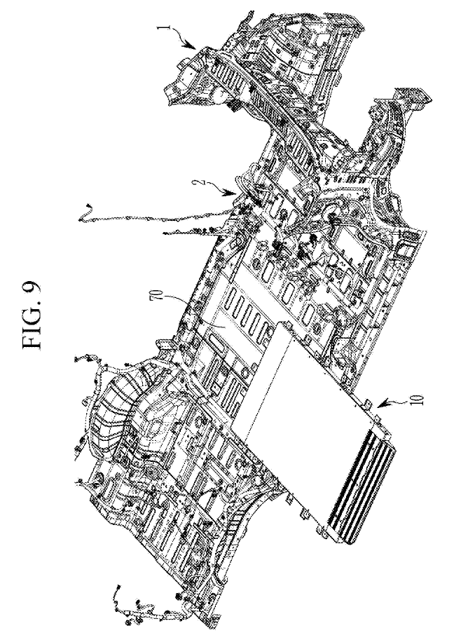

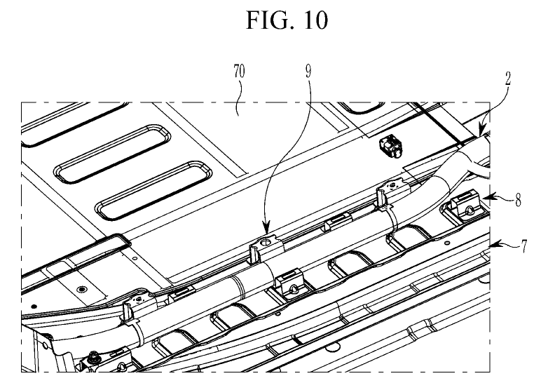

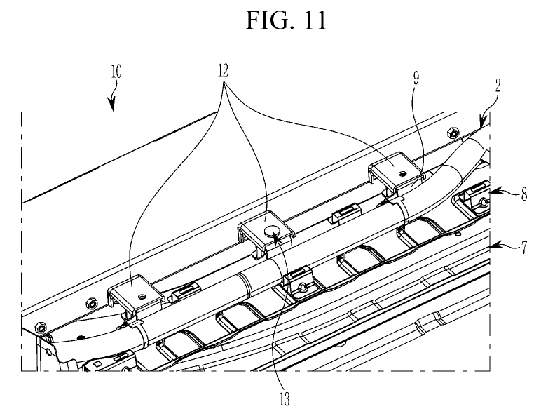

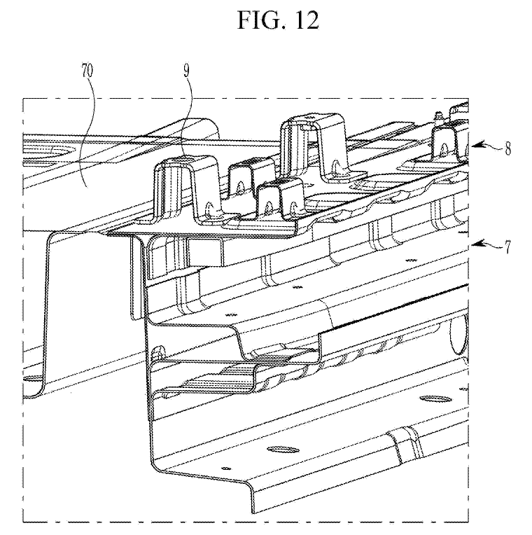

FIG. 9 shows a state in which an in-floor ramp module of a ramp module mounting structure of a vehicle according to some embodiments of the present disclosure may be installed above a center floor panel inside the vehicle. FIG. 10 shows a ramp module assembly guide to which an end portion of an in-floor ramp module of a ramp module mounting structure of a vehicle according to some embodiments of the present disclosure may be assembled. FIG. 11 shows a state in which a side ramp module coupling bracket of a ramp module mounting structure of a vehicle according to some embodiments of the present disclosure may be coupled and fixed to the ramp module assembly guide. FIG. 12 is a partially cut-away perspective view of a structure of a side sill of a ramp module mounting structure of a vehicle according to some embodiments of the present disclosure.

As shown in FIGS. 9, 11 and 14, in some embodiments, a plurality of side ramp module coupling brackets 12 may be provided at an end portion of the in-floor ramp module 10 so as to be fixed to the side sill 7 installed on one side of the vehicle body 1. In some embodiments, the plurality of side ramp module coupling brackets 12 may be provided to protrude only at an end portion of one side of the in-floor ramp module 10 coupled to the side sill 7, and may not be provided on the opposite side of the in-floor ramp module 10 that is slidably moved toward the outside of the vehicle body 1.

As shown in FIGS. 10 to 12, in some embodiments, a patch panel 8 may be attached to an upper surface of the side sill 7, and the ramp module assembly guide 9, to which one side of the ramp module 10 may be assembled, may be assembled on an upper portion of the patch panel 8. In some embodiments, the ramp module assembly guide 9 may be installed in plurality to correspond to the plurality of side ramp module coupling brackets 12.

In some embodiments, the ramp module assembly guide 9 may have a tunnel shape protruding upward, and the side ramp module coupling bracket 12 may be coupled to a protruded upper surface of ramp module assembly guide 9 while overlapping the same. In some embodiments, the side ramp module coupling bracket 12 may be seated on and coupled to an upper portion of the ramp module assembly guide 9 by a bolt 13.

In some embodiments, a height of a combination of the ramp module assembly guide 9 and the side ramp module bracket 12 may be higher than a height of the slide wiring 2 so as not to interfere with the slide wiring 2. In some embodiments, the slide wiring 2 may be disposed in a form extending in a longitudinal direction through an inside of the tunnel shape of the ramp module assembly guide 9.

As shown in FIG. 12, in some embodiments, an inside of the side sill 7 may form an annular structure in which a plurality of panels are provided while forming gaps. In some embodiments, an upper surface of the side sill 7 may be formed of a double panel structure to which the patch panel 8 is attached. In some embodiments, such an annular structure and double panel structure of the side sill 7 and the patch panel 8 can improve support rigidity of the vehicle body, and can improve collision durability of the side sill 7 and the vehicle body 1 by absorbing an impact from an outside of the vehicle body 1.

FIG. 13 shows an arrangement structure of members disposed at a lower portion of an in-floor ramp module of a ramp module mounting structure of a vehicle according to some embodiments of the present disclosure.

As shown in FIG. 13, in some embodiments, a longitudinal side member 40, a transverse battery member 50, and an extension member 60 may be provided at the lower portion of the in-floor ramp module 10.

In some embodiments, the longitudinal side member 40 may be provided on both left and right sides of the vehicle body 1 and may extend in a longitudinal direction of the vehicle body 1. In some embodiments, the transverse battery member 50 may have both ends connected to the longitudinal side members 40, and a battery module 4 may be mounted thereon. The transverse battery member 50 may be formed of a plurality of members arranged to be parallel with each other. The extension member 60 may connect the vehicle body 1 and the transverse battery member 50, and may extend in a longitudinal direction of the vehicle body 1. The extension member 60 may be formed of a plurality of members arranged to be parallel with each other.

In some embodiments, the extension member 60 may be formed of a front extension member 62 connecting the vehicle body 1 at a front and the transverse battery member 50 at a front, and a rear extension member 64 connecting the vehicle body 1 at a rear and the transverse battery member 50 at a rear. As illustrated in FIG. 13, in some embodiments, the front extension member 62 and the rear extension member 64 each may be formed of a plurality of members.

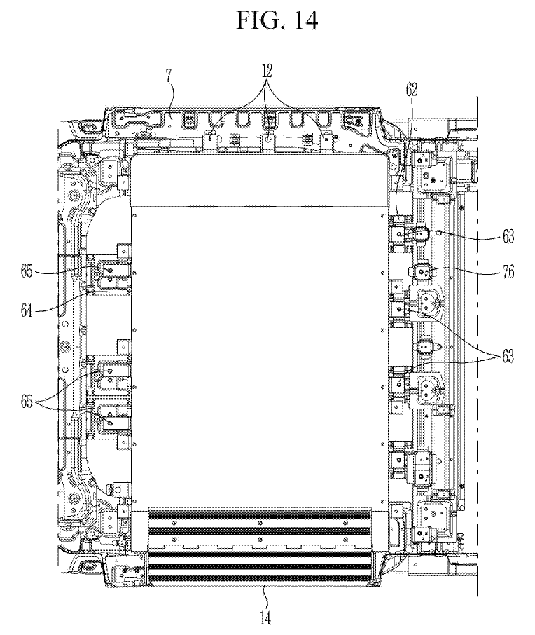

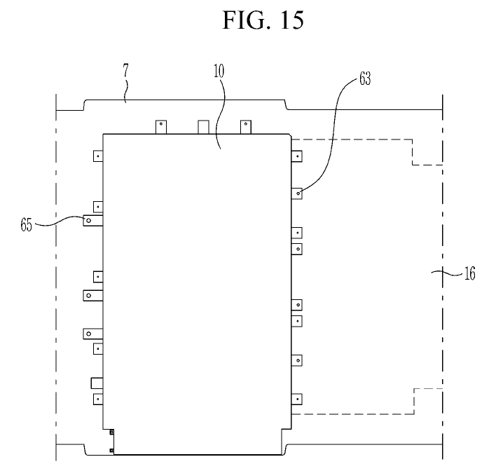

FIG. 14 shows a state in which an in-floor ramp module of a ramp module mounting structure of a vehicle according to some embodiments of the present disclosure may be mounted on members disposed at a lower portion of the in-floor ramp module. FIG. 15 shows front and rear ramp module coupling brackets provided in an in-floor ramp module of a ramp module mounting structure of a vehicle according to some embodiments of the present disclosure.

As illustrated in FIGS. 14 and 15, in some embodiments, a front ramp module coupling bracket 63 mounted on the front extension member 62 may be provided on a front side of the in-floor ramp module 10, and a rear ramp module coupling bracket 65 mounted on the rear extension member 6 may be provided on a rear side of the in-floor ramp module 10. In some embodiments, the front ramp module coupling bracket 63 and the rear ramp module coupling bracket 65 each may be provided in plurality to correspond to the front extension member 62 and the rear extension member 64.

In some embodiments, a ramp slide protruding portion 14 configured to extend from an upper portion of the side sill 7 toward the outside of the vehicle body 1 may be provided on one side of the in-floor ramp module 10. In some embodiments, the slide protruding portion 14 may be in a form extending from the upper portion of the side sill 7 toward the outside of the vehicle body 1, and may serve to cover and protect an upper surface and an end of the in-floor ramp module 10. However in some embodiments, the slide protruding portion 14 may not be provided on the in-floor ramp module 10, depending on design specifications of the ramp module.

In some embodiments, planarization panel mounting brackets 76 on which the front planarization panel 20 and the rear planarization panel 30 may be mounted may be further provided on the floor surface of the vehicle body 1.

As such, in some embodiments, the longitudinal extension member 60, the transverse battery member 50, and the longitudinal side member 40 may be connected together, and the in-floor ramp module 10 may be further connected through the ramp module coupling brackets 63 and 65 such that a lattice structure may be formed, thereby suppressing movement of the in-floor ramp module 10 forward front and rear of the vehicle and improving durability and rigidity of the vehicle body 1.

FIG. 16 shows an arrangement relationship between an in-floor ramp module, a side member, and a side sill of ramp module mounting structure of a vehicle according to an example embodiment of the present disclosure.

As shown in FIG. 16, in some embodiments, the side sill 7 may be disposed on both side portions of the vehicle body 1, the longitudinal side member 40 may be disposed inside each side sill 7, and a position of the in-floor ramp module 10 may be fixed between both longitudinal side members 40. In some embodiments, at a lower portion of the in-floor ramp module 10, not only the longitudinal side member 40 but also the transverse battery member 50 and the extension member 60 may be provided, and the battery module 4 may be mounted on both longitudinal side members 40 at a lower portion of the in-floor ramp module 10.

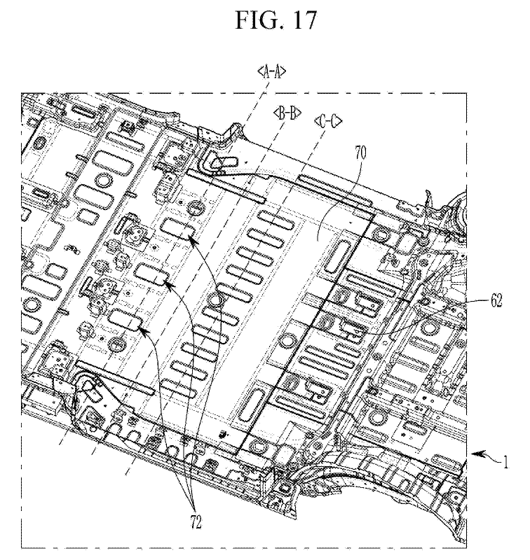

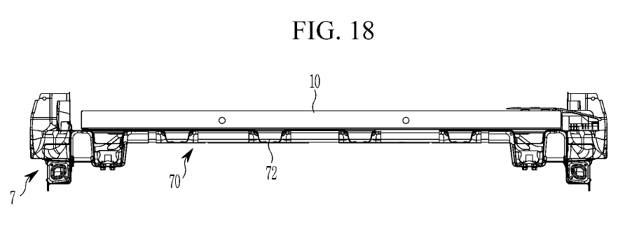

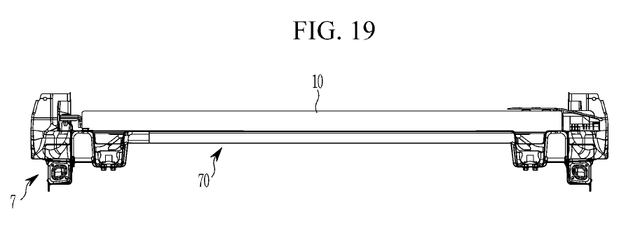

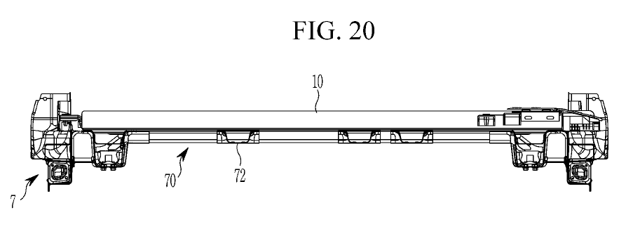

FIG. 17 shows a center floor panel on which an in-floor ramp module of a ramp module mounting structure of a vehicle according to an example embodiment of the present disclosure may be mounted. FIG. 18 is a cross-sectional view of FIG. 17, taken along the line <A-A>. FIG. 19 is a cross-sectional view of FIG. 17, taken along the line <B-B>. FIG. 20 is a cross-sectional view of FIG. 17, taken along the line <C-C>.

As illustrated in FIG. 17, in some embodiments, a center floor panel 70 may be provided between a lower portion of the in-floor ramp module 10, the longitudinal side member 40, the transverse battery member 50, and the extension member 60, and a plurality of negative beads 72 may be formed on an upper surface of the center floor panel 70. The bead 72 may be formed as a plurality of beads arranged in parallel with the same shape in a transverse direction, and the number of beads may be variously changed.

As illustrated in FIGS. 18 and 20, in some embodiments, a plurality of beads 72 may be formed on a center floor panel 70 at a lower portion of the in-floor ramp module 10. The bead 72 may be a negative type formed in a “U” shape recessed downward from an upper surface of the center floor panel 70. In some embodiments, as illustrated in FIG. 19, the bead 72 may not be formed on some portions of the center floor panel 70.

In some embodiments, by forming such a negative-type bead 72 on the center floor panel 70, noise, vibration, and harshness (NVH) performance of the vehicle may be improved, and a ground clearance may be lowered as much as possible, thereby reducing a slope length of the in-floor ramp module 10 through which a wheelchair can move as much as possible.

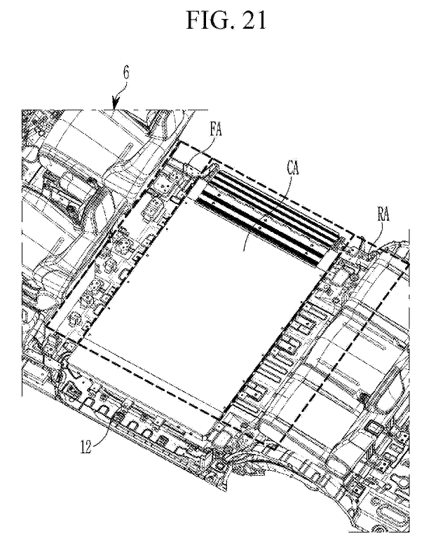

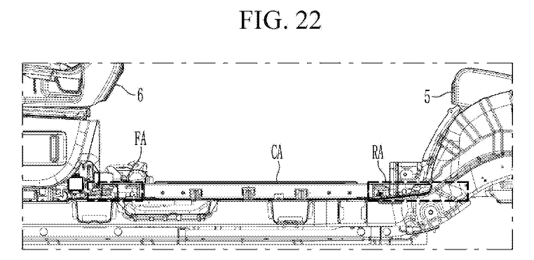

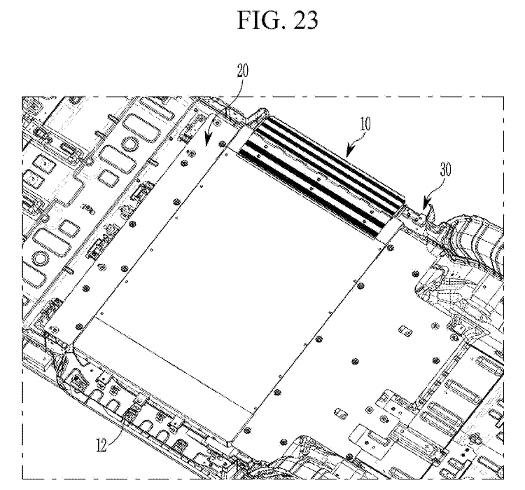

FIG. 21 is a perspective view of a planarized region of a ramp module mounting structure of a vehicle according to an example embodiment of the present disclosure. FIG. 22 is a cross-sectional view of a planarized region of a ramp module mounting structure of a vehicle according to an example embodiment of the present disclosure. FIG. 23 shows a state in which a planarization panel of a ramp module of a vehicle may be provided according to an example embodiment of the present disclosure.

As illustrated in FIGS. 21 to 23, in some embodiments, a center planarization area CA may be formed on an upper surface of the in-floor ramp module 10, a front planarization area FA may be formed between the in-floor ramp module 10 and the front seat 6, and a rear planarization area RA may be formed between the in-floor ramp module 10 and the tip-up seat 5. In some embodiments, a front planarization panel 20 may be installed to be the same height as the upper surface of the in-floor ramp module 10 in the front planarization area FA, and a rear planarization panel 30 may be installed to be the same height as the upper surface of the in-floor ramp module 10 in the rear planarization area RA. Therefore in some embodiments, a floor surface inside the vehicle between the front seat 6 and the tip-up seat 5 may be planarized such that a wheelchair passenger can move smoothly and safely inside the vehicle.

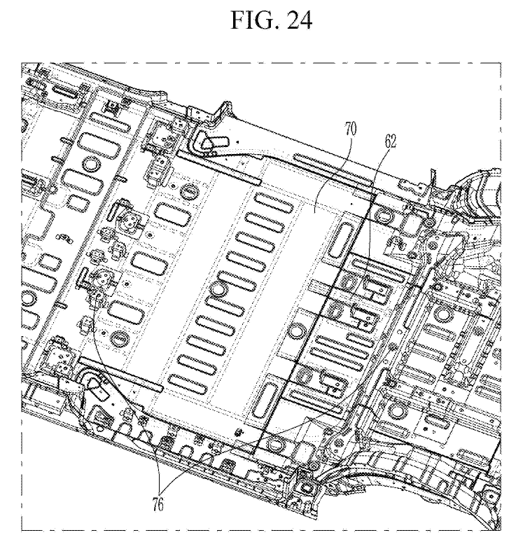

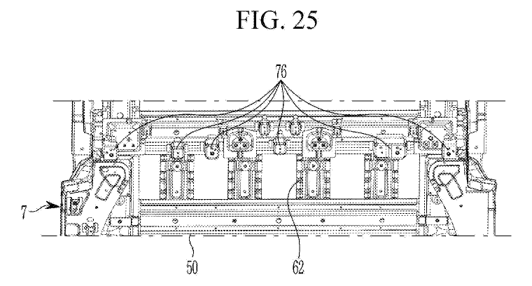

FIG. 24 shows planarization panel mounting brackets of a ramp module mounting structure of a vehicle according to an example embodiment of the present disclosure. FIG. 25 shows a state in which planarization panel mounting brackets of a ramp module mounting structure of a vehicle according to an example embodiment of the present disclosure may be coupled with a transverse battery member through an extension member.

As illustrated in FIG. 24, in some embodiments, planarization panel mounting brackets 76 on which the front planarization panel 20 and the rear planarization panel 30 may be mounted may be further provided on the floor surface of the vehicle body 1. The planarization panel mounting brackets 76 may be provided at front and rear of the in-floor ramp module 10, that is, positions where the front planarization panel 20 and the rear planarization panel 30, respectively, may be mounted.

As illustrated in FIG. 25, in some embodiments, the planarization panel mounting brackets 76 may be installed at a portion where the front extension member 62 and the vehicle body 1 are connected, and may be connected to the transverse battery member 50 through the front extension member 62. Accordingly, in some embodiments, the front planarization panel 20 can be additionally supported by the transverse battery member 50 after being mounted on the planarization panel mounting bracket 76, thereby improving support rigidity of the front planarization panel 20.

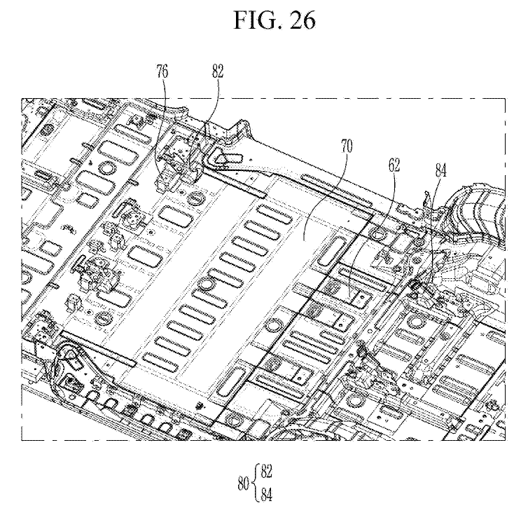

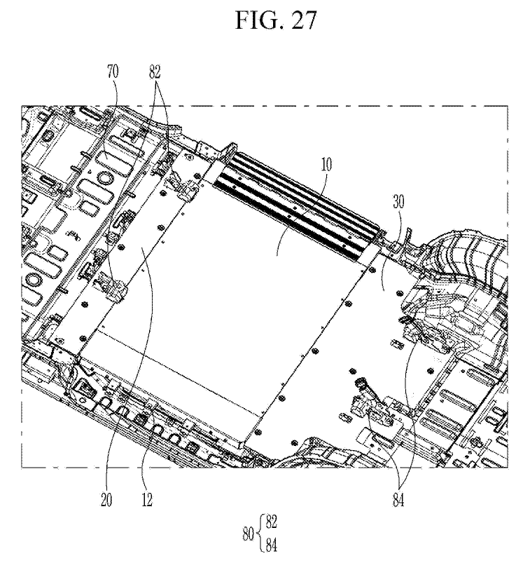

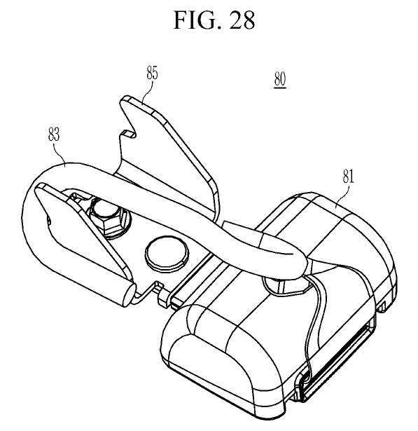

FIG. 26 shows a state in which a wheelchair restraint device may be installed on a floor surface of a vehicle body of a ramp module mounting structure of a vehicle according to an example embodiment of the present disclosure. FIG. 27 shows a state in which an in-floor ramp module, a planarization panel, and a wheelchair restraint device may be installed in a ramp module mounting structure for a vehicle according to an example embodiment of the present disclosure. FIG. 28 shows a wheelchair restraint device of a ramp module mounting structure of a vehicle according to an example embodiment of the present disclosure.

As illustrated in FIG. 26, in some embodiments, a wheelchair restraint device 80 that fixes a wheelchair placed on the in-floor ramp module 10 may be further provided on the floor surface of the vehicle body 1. In some embodiments, the wheelchair restraint device 80 may be formed of two front wheelchair restraint devices 82 disposed at a rear side of the front seat 6 and two rear wheelchair restraint devices 84 disposed at a front side of the tip-up seat 5.

As illustrated in FIG. 27, in some embodiments, the front wheelchair restraint devices 82 may be installed to be protruded to an upper surface of the front planarization panel 20, and the rear wheelchair restraint devices 84 may be installed to be protruded to an upper surface of the rear planarization panel 30.

As illustrated in FIG. 28, in some embodiments, the wheelchair restraint device 80 may be formed of a body portion 81 fixed to the floor surface of the vehicle body 1, a hook portion 83 connected to be rotatable to the body portion 81 and fixing a wheel of the wheelchair by hooking, and a support portion 85 integrally formed with the body portion 81 and supporting the wheel of the wheelchair.

In some embodiments, the body portion 81 and the support portion 85 may be fixed to the floor surface of the vehicle body 1. In some embodiments, the hooking portion 83 may have one end connected to the body portion 81, and the other end may be formed in a curved shape so as to be hooked onto the wheel of the wheelchair. In some embodiments, a groove may be formed at an end of the support portion 85 such that the other end of the hook portion 83 can be hooked and coupled to the end of the support portion 85 when the wheel of the wheelchair is not fixed (for storage of and securing the hooking portion 83).

As described above, according to some embodiments of the present disclosure, by adopting a structure in which an in-floor ramp module for boarding of the mobility-impaired is mounted on a lower radial vehicle body member, it is possible to respond to a multi-specification PBV market by using as much commonality as possible without changes to existing vehicle types.

In some embodiments, by adopting a ramp device that can be planarized along with a planarization panel, the appearance becomes beautiful and loading and usability can be improved.

In some embodiments, by adopting a side sill forming an annular structure in which a plurality of panels are provided while forming gaps, rigidity and durability of the vehicle body can be improved.

In some embodiments, by planarizing the entire in-floor surface after mounting the ramp module and adopting a device for restraining a wheelchair, ride comfort and safety can be improved.

Although some example embodiments regarding the present disclosure have been described above, the present disclosure is not necessarily limited to the example embodiments, and includes all changes within the scopes that can be changed and recognized as equivalent by those skilled in the art to which the disclosure pertains from the example embodiments of the present disclosure for other embodiments of the present disclosure.

What is claimed is:

1. A ramp module mounting structure of a vehicle installed on a vehicle body inside the vehicle, the ramp module mounting structure comprising:
an in-floor ramp module disposed on a floor surface of the vehicle body and configured to be slidably moved toward an outside of the vehicle body in a transverse direction of the vehicle body;
longitudinal side members, wherein each of the longitudinal side members fixes a position of the in-floor ramp module at both sides of the in-floor ramp module; and
a battery disposed at a lower portion of the in-floor ramp module.

2. The ramp module mounting structure of claim 1, further comprising:
a front planarization panel disposed on the floor surface of the vehicle body and disposed at a front end portion of the in-floor ramp module; and
a rear planarization panel disposed on the floor surface of the vehicle body and disposed at a rear end portion of the in-floor ramp module, wherein upper planar surfaces of the in-floor ramp module, the front planarization panel, and the rear planarization panel are on a same plane.

3. The ramp module mounting structure of claim 1, further comprising a wiring harness disposed at one side of the vehicle body and the in-floor ramp module, wherein a slide ramp operation portion of the in-floor ramp module is disposed at an opposite side of the wiring harness.

4. The ramp module mounting structure of claim 1, further comprising:
side sills, wherein each of the side sills is disposed at an outer portion of each of the longitudinal side members;
a patch panel attached to an upper surface of a first side sill of the side sills; and
a ramp module assembly guide disposed on an upper portion of the patch panel, wherein an end portion of the in-floor ramp module is attached to the ramp module assembly guide.

5. The ramp module mounting structure of claim 4, further comprising a side ramp module coupling bracket disposed to protrude from the end portion of the in-floor ramp module and coupled with the ramp module assembly guide to fix the in-floor ramp module to the ramp module assembly guide.

6. The ramp module mounting structure of claim 5, further comprising a slide wiring harness disposed at one side of the vehicle body, wherein a first height of the ramp module assembly guide is disposed to be higher than a second height of the slide wiring harness with a configuration so as not to interfere with the slide wiring harness.

7. The ramp module mounting structure of claim 4, wherein an interior of each of the side sills includes an annular structure comprising a plurality of panels disposed in forming intervals.

8. The ramp module mounting structure of claim 7, further comprising a slide wiring harness disposed on the first side sill outside of the in-floor ramp module.

9. The ramp module mounting structure of claim 1, further comprising:
a transverse battery member extending in a transverse direction of the vehicle body under the in-floor ramp module and connected to the longitudinal side members, wherein the battery module is mounted on the transverse battery member; and
an extension member connecting the vehicle body and the transverse battery member and extending in a longitudinal direction of the vehicle body.

10. The ramp module mounting structure of claim 9, wherein the extension member comprises:
a front extension member connecting a front portion of the vehicle body and the transverse battery member; and
a rear extension member connecting a rear portion of the vehicle body and the transverse battery member.

11. The ramp module mounting structure of claim 10, further comprising:
a front ramp module coupling bracket mounted to the front extension member extending from a front side the in-floor ramp module, and
a rear ramp module coupling bracket mounted to the rear extension member extending from a rear side of the in-floor ramp module.

12. The ramp module mounting structure of claim 4, further comprising a ramp slide protrusion portion disposed to extend toward the outside of the vehicle body from a side portion of the in-floor ramp module over an upper portion of a second side sill of the side sills.

13. The ramp module mounting structure of claim 9, further comprising a center floor panel disposed between the lower portion of the in-floor ramp module, the longitudinal side members, the transverse battery member, and the extension member.

14. The ramp module mounting structure of claim 13, wherein the center floor panel comprises a plurality of negative beads on an upper surface of the center floor panel.

15. The ramp module mounting structure of claim 2, further comprising a wheelchair restraint device disposed on the floor surface of the vehicle body.

16. The ramp module mounting structure of claim 15, wherein the wheelchair restraint device comprises:
a front wheelchair restraint device protruding at the upper planar surface of the front planarization panel; and
a rear wheelchair restraint device protruding at the upper planar surface of the rear planarization panel.

17. A vehicle comprising:
side sills extending along a longitudinal direction of the vehicle;
an in-floor ramp module disposed between the side sills, wherein the in-floor ramp module includes an in-floor-ramp-module upper planar surface, and wherein the in-floor ramp module includes internal components configured to slidably move toward an outside of the vehicle in a transverse direction of the vehicle; and
a battery disposed below the in-floor ramp module.

18. The vehicle of claim 17, further comprising:
a front planarization panel disposed adjacent a front side of the in-floor ramp module, wherein the front planarization panel includes a front-planarization-panel upper planar surface; and
a rear planarization panel disposed adjacent a rear side of the in-floor ramp module, wherein the rear planarization panel includes a rear-planarization-panel upper planar surface,
wherein the in-floor-ramp-module upper planar surface, the front-planarization-panel upper planar surface, and the rear-planarization-panel upper planar surface are on a same plane, and
wherein an interior floor of the vehicle comprises the in-floor-ramp-module upper planar surface, the front-planarization-panel upper planar surface, and the rear-planarization-panel upper planar surface.

19. The vehicle of claim 18, further comprising:
a front wheelchair restraint device disposed at the front-planarization-panel upper planar surface; and
a rear wheelchair restraint device disposed at the rear-planarization-panel upper planar surface.

20. A vehicle comprising:
side sills extending along a longitudinal direction of the vehicle;
a front seat disposed at a front side of the vehicle in an interior of the vehicle;
a rear seat disposed at a rear side of the vehicle in the interior of the vehicle;
an in-floor ramp module disposed between the side sills, wherein the in-floor ramp module includes an in-floor-ramp-module upper planar surface, and wherein the in-floor ramp module includes internal components configured to slidably move toward an outside of the vehicle in a transverse direction of the vehicle, wherein the in-floor ramp module is disposed between the front seat and the rear seat;
a battery disposed below the in-floor ramp module, wherein the battery is disposed between the front seat and the rear seat;
a front planarization panel disposed adjacent a front side of the in-floor ramp module, wherein the front planarization panel includes a front-planarization-panel upper planar surface;
a rear planarization panel disposed adjacent a rear side of the in-floor ramp module, wherein the rear planarization panel includes a rear-planarization-panel upper planar surface,
wherein the in-floor-ramp-module upper planar surface, the front-planarization-panel upper planar surface, and the rear-planarization-panel upper planar surface are on a same plane, and
wherein the interior of the vehicle includes an open interior space between the front seat and the rear seat, wherein the open interior space has an open-interior floor comprising the in-floor-ramp-module upper planar surface, the front-planarization-panel upper planar surface, and the rear-planarization-panel upper planar surface;
a front wheelchair restraint device disposed at the front-planarization-panel upper planar surface; and
a rear wheelchair restraint device disposed at the rear-planarization-panel upper planar surface.
